(19) United States
(12) Patent Application Publication
(10) Pub. No.: US 2010/0054166 A1
(43) Pub. Date: Mar. 4, 2010

(54) APPARATUS AND METHOD FOR CONTROLLING IDLE MODE OF MOBILE STATION IN A WIRELESS COMMUNICATION SYSTEM

(75) Inventor: Yong-Jae JUNG, Seoul (KR)

Correspondence Address: Jefferson IP Law, LLP, 1130 Connecticut Ave., NW, Suite 420, Washington, DC, 20036, US

(73) Assignee: Samsung Electronics Co., Ltd., Suwon-si (KR)

(21) Appl. No.: 12/552,564

(22) Filed: Sep. 2, 2009

(30) Foreign Application Priority Data
Sep. 2, 2008 (KR) 10-2008-0086212

(51) Int. Cl. G08C 17/00; H04W 68/00; H04L 27/28

(52) U.S. Cl. 370/311; 455/458; 375/260

(57) ABSTRACT

An apparatus and method for transmitting a paging message in a wireless communication system are provided. A method for operation transition of a communication module operating in an idle mode includes, when a listening interval arrives, determining if a paging message is received, when the paging message is not received during the listening interval, determining if paging information on the communication module is received from a different communication module, and, when the paging information is received from the different communication module, transiting to an active mode.

### PRIORITY

This application claims the benefit under 35 U.S.C. §119(a) to a Korean patent application filed in the Korean Intellectual Property Office on Sep. 2, 2008 and assigned Serial No. 10-2008-0086212, the entire disclosure of which is hereby incorporated by reference.

### BACKGROUND OF THE INVENTION

1. Field of the Invention

The present invention relates to an apparatus and method for controlling an idle mode of a Mobile Station (MS) in a wireless communication system. More particularly, the present invention relates to an apparatus and method for transmitting a paging message to an MS operating in an idle mode in a wireless communication system.

2. Description of the Related Art

In a wireless communication system, an MS has limited power reserves and therefore must be judicious with its power consumption. Accordingly, when not performing packet transmission/reception for a predefined time, the MS operates in an idle mode or sleep mode to reduce power consumption.

When the MS operates in the idle mode, if there is a packet for the MS to transmit, the MS transitions into an active mode and transmits the packet.

When operating in the idle mode, the MS determines if there is a packet to receive through a paging message periodically transmitted by a Base Station (BS). For example, as illustrated in FIG. 1 below, the MS periodically wakes up and determines if the paging message of the BS is received.

FIG. 1 illustrates a listening interval of an MS operating in an idle mode in a wireless communication system according to the conventional art.

As illustrated in FIG. 1, the MS operating in the idle mode 100 wakes up only at a listening interval 103 every paging period 101 and determines if a paging message transmitted by a BS is received.

The MS determines if a mode transition should occur depending on the existence or non-existence of a packet for the MS to receive that is determined through the paging message. For example, during a first listening interval 120, the MS wakes up to determine if there is a paging message received that indicates there is a packet for the MS to receive. The MS determines that there is no paging message received that indicates there is a packet for the MS to receive and thus operates in the idle mode 100. Similarly, during a second listening interval 130, the MS again wakes up to determine if there is a paging message received that indicates there is a packet for the MS to receive. In this case, the MS fails to receive the paging message and returns to the idle mode 100, waiting for an idle interval 105 to expire before waking up again to determine if it receives a paging message received that indicates there is a packet for the MS to receive. On the other hand, during a third listening interval 140, the MS determines that there is a paging message received that indicates there is a packet for the MS to receive and the MS transitions to an active mode 110.

As described above, an MS operating in an idle mode wakes up only at a listening interval and determines if there is a packet for the MS to receive through a paging message received from a BS.

However, as in the second listening interval 130 described above, if the MS fails to receive the paging message during the listening interval, for example because of the influence of a wireless environment, there occurs a problem that the MS cannot determine if there is a packet for the MS to receive.

Further, if there is a packet for a BS to transmit to an MS, the BS informs that there is the packet to be transmitted to the MS through a paging message. However, if the MS fails to receive the paging message, the MS cannot determine if there is a packet for the MS to receive and thus operates in an idle mode. Thus, there is a problem that packet transmission is delayed.

### SUMMARY OF THE INVENTION

An aspect of the present invention is to address at least the above-mentioned problems and/or disadvantages and to provide at least the advantages below. Accordingly, an aspect of the present invention is to provide an apparatus and method for reducing a response delay time of a Mobile Station (MS), which operates in an idle mode, responsive to a paging message in a wireless communication system.

Another aspect of the present invention is to provide an apparatus and method for reducing a response delay time of a dual mode MS, which operates in an idle mode, responsive to a paging message in a wireless communication system.

A further aspect of the present invention is to provide an apparatus and method for improving the reliability of transmission of a paging message transmitted to an MS operating in an idle mode in a Base Station (BS) of a wireless communication system.

Yet another aspect of the present invention is to provide an apparatus and method for improving the reliability of transmission of a paging message transmitted to an MS operating in an idle mode in a BS of a wireless communication system supporting a dual mode.

The above aspects are addressed by providing an apparatus and method for controlling an idle mode of an MS in a wireless communication system.

According to an aspect of the present invention, a method for operation transition of a communication module operating in an idle mode in a mobile communication terminal having at least two communication modules is provided. The method includes, when a listening interval arrives, determining if a paging message is received, when the paging message is not received during the listening interval, determining if paging information on the communication module is received from a different communication module, and, when the paging information is received from the different communication module, transiting to an active mode.

According to another aspect of the present invention, a method for controlling paging message transmission in a call control unit of a wireless communication system is provided. The method includes, if transmitting a packet to a Mobile Station (MS), determining an operation state of a first communication module for packet transmission among at least two communication modules constituting the MS, and, if the first communication module operates in an idle mode, transmitting idle mode information on the first communication module to at least two Base Stations (BSs) of different communication schemes that the MS can access.

According to a further aspect of the present invention, a method for transmitting a paging message in a BS of a wireless communication system is provided. The method includes, if receiving, from a call control unit, idle mode information on a first communication module that is one of at least two communication modules constituting an MS, determining a communication scheme of the first communication module, and, if the communication scheme of the first communication module is different from a communication scheme of the BS, transmitting paging information on the first communication module to a second communication module using the same communication scheme as the BS among the at least two communication modules constituting the MS.

According to a yet another aspect of the present invention, a mobile communication MS apparatus having at least two communication modules is provided. The apparatus includes a first communication module and a second communication module. If paging information on a second communication module is received from a serving BS of a first communication scheme, the first communication module transmits the paging information on the second communication module to the second communication module operating in an idle mode. When operating in the idle mode, if paging information on the second communication module is received from the first communication module although a paging message is not received during a listening interval, the second communication module transitions to an active mode.

According to a still another aspect of the present invention, a call control apparatus for controlling paging message transmission in a wireless communication system is provided. The apparatus includes a storage unit, at least two interfaces, and a controller. The storage unit stores operation state information on at least two communication modules constituting an MS. The at least two interfaces perform communication with BSs of different communication schemes. If a first communication module for packet transmission among the communication modules constituting the MS operates in an idle mode, the controller controls to transmit idle mode information on the first communication module to the at least two BSs of the different communication schemes that the MS can access through the interfaces.

According to a still another aspect of the present invention, a BS apparatus for transmitting a paging message in a wireless communication system is provided. The apparatus includes a wired interface, a transmitter, a receiver, and a controller. The wired interface performs communication with a call control unit. The transmitter transmits a signal. The receiver receives a signal. If receiving idle mode information on a first communication module using a communication scheme different from a BS among at least two communication modules constituting an MS through the wired interface, the controller controls to transmit paging information on the first communication module to a second communication module using the same communication scheme as the BS.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments the present invention will be more apparent from the following description taken in conjunction with the accompanying drawings, in which:

FIG. 1 is a diagram illustrating a listening interval of a Mobile Station (MS) operating in an idle mode in a wireless communication system according to the conventional art;

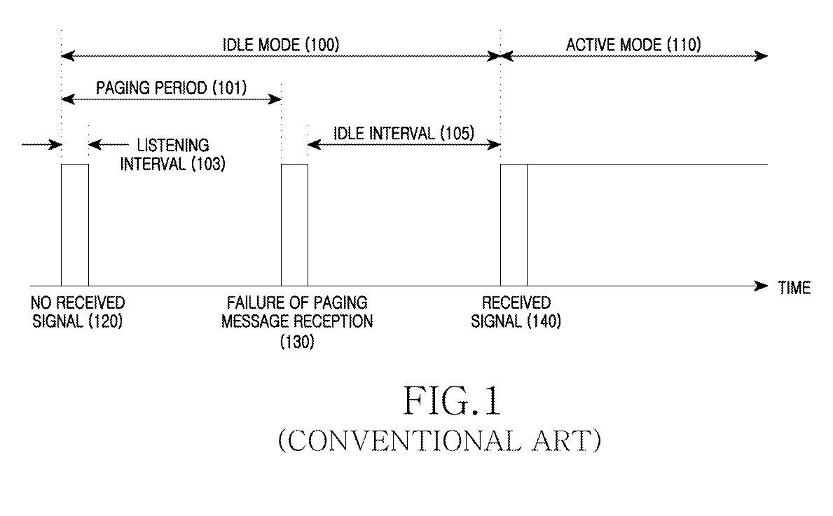

FIG. 2 is a diagram illustrating a construction of a wireless communication system according to an exemplary embodiment of the present invention;

FIG. 3 is a ladder diagram illustrating a procedure for an idle mode transition of an MS in a wireless communication system according to an exemplary embodiment of the present invention;

FIG. 4 is a flow diagram illustrating a procedure for transmitting a paging message in a call control unit according to an exemplary embodiment of the present invention;

FIG. 5 is a flow diagram illustrating a procedure for transmitting a paging message in a Base Station (BS) according to an exemplary embodiment of the present invention;

FIG. 6 is a flow diagram illustrating a procedure for determining paging information on a different communication module in a dual mode MS according to an exemplary embodiment of the present invention;

FIG. 7 is a flow diagram illustrating a procedure for controlling an active mode transition of a communication module in a dual mode MS according to an exemplary embodiment of the present invention;

FIG. 8 is a flow diagram illustrating a procedure for active mode transition in a dual mode MS according to an exemplary embodiment of the present invention;

FIG. 9 is a block diagram illustrating a construction of a call control unit for transmitting a paging message to a dual mode MS according to an exemplary embodiment of the present invention;

FIG. 10 is a block diagram illustrating a construction of a BS for transmitting a paging message to a dual mode MS according to an exemplary embodiment of the present invention; and

FIG. 11 is a block diagram illustrating a construction of a dual mode MS according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The following description is made for a technology for enhancing the reliability of transmission of a paging message transmitted to a Mobile Station (MS) operating in an idle mode in a wireless communication system.

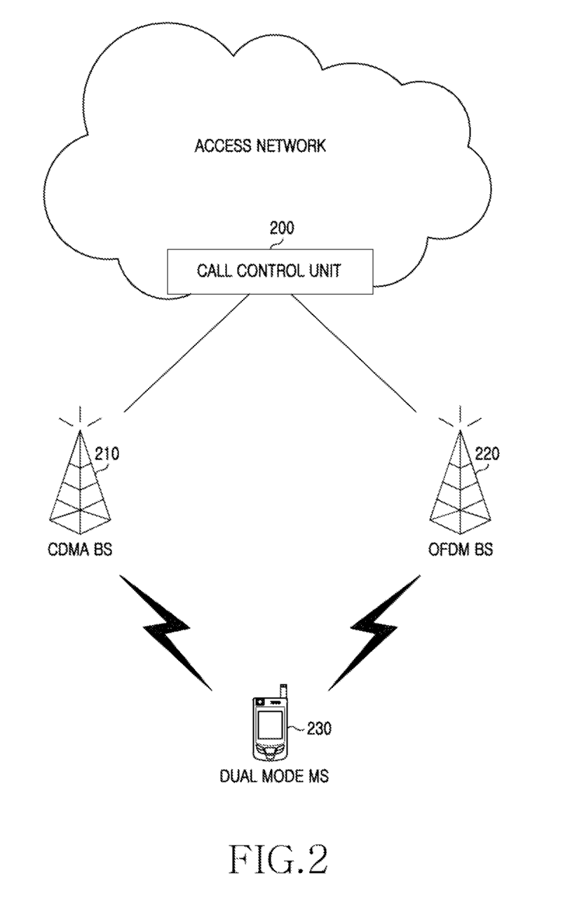

In the following description, it is assumed that the wireless communication system provides services of a plurality of communication schemes as illustrated in FIG. 2 below.

Also, it is assumed that an MS operates in a multi mode that enables the selective use of a plurality of communication schemes. In the following description, it is assumed that the MS supports a Code Division Multiple Access (CDMA) scheme and an Orthogonal Frequency Division Multiple Access (OFDMA) scheme. Also, exemplary embodiments of the present invention are identically applicable to when the MS supports other communication schemes.

FIG. 2 illustrates a construction of a wireless communication system according to an exemplary embodiment of the present invention.

As illustrated in FIG. 2, the wireless communication system provides a communication service of a CDMA scheme and a communication service of an OFDMA scheme. An MS 230 includes a CDMA communication module and an OFDM communication module to selectively use the CDMA communication service and the OFDMA communication service.

If a specific user attempts a call to the MS 230 through an access network, a call control unit 200 determines if the MS 230 has registered with a CDMA Base Station (BS) 210 or an OFDM BS 220. If the MS 230 is not registered with the CDMA BS 210 and the OFDM BS 220, the call control unit 200 informs the user of call disability information. Also, if the MS 230 is not registered with a BS of a communication scheme in which the user requests a call, the call control unit 200 may inform the user of call disability information.

On the other hand, if the MS 230 has registered with the CDMA BS 210 and the OFDM BS 220, the call control unit 200 selects a BS for connecting a call to the MS 230 depending on a communication scheme in which the user requests a call. For example, if the user requests a call in the CDMA scheme, the call control unit 200 informs the MS 230 of the user's call request through the CDMA BS 210. On the other hand, if the user requests a call in the OFDMA scheme, the call control unit 200 informs the MS 230 of the user's call request through the OFDM BS 220.

Accordingly, the MS 230 performs communication with the CDMA BS 210 using the CDMA communication module, and performs communication with the OFDM BS 220 using the OFDM communication module.

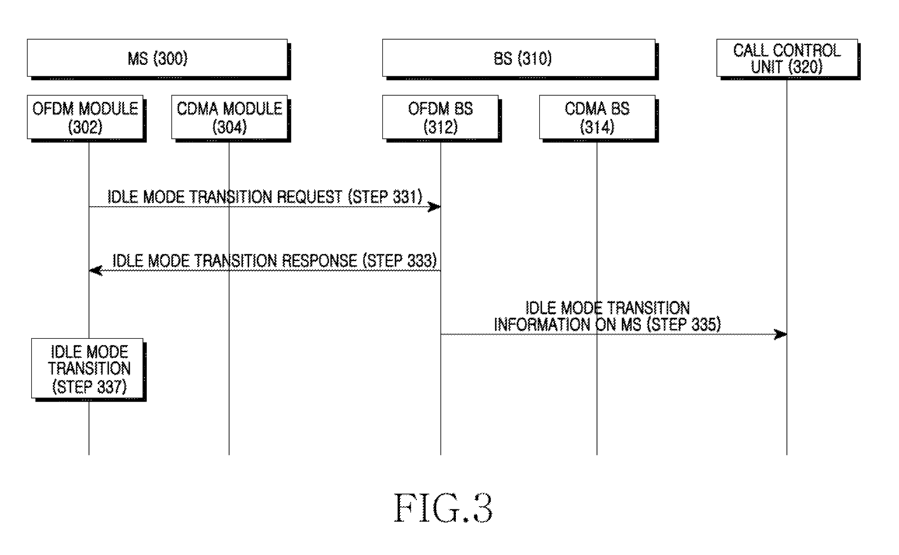

As described above, an MS that selectively uses either a CDMA communication service or an OFDMA communication service transitions the communication module not performing communication for a predefined time into an idle mode to reduce power consumption. For example, if an MS does not perform communication using an OFDM communication module for a predefined time, the MS transitions the OFDM communication module into the idle mode as illustrated in FIG. 3 below.

FIG. 3 illustrates a procedure for an idle mode transition of an MS in a wireless communication system according to an exemplary embodiment of the present invention.

As illustrated in FIG. 3, if the MS 300 does not use an OFDM module 302 for a predefined time, in step 331, the OFDM module 302 transmits an idle mode transition request message to an OFDM BS 312.

Then, in step 333, the OFDM BS 312 transmits a response message to the OFDM module 302 in response to the idle mode transition request of the OFDM module 302. At this time, the OFDM BS 312 transmits idle mode operation information on the OFDM module 302 to the OFDM module 302. Here, the idle mode operation information includes a time at which the OFDM module 302 transitions to an idle mode, a paging period, a listening interval length, etc.

In step 335, the OFDM BS 312 transmits idle mode transition information on the OFDM module 302 of the MS 300 to a call control unit 320.

The call control unit 320 stores operation state information on the OFDM module 302 and CDMA module 304 of the MS 300 depending on the idle mode transition information received from the OFDM BS 312.

In step 337, the OFDM module 302 transitions to an idle mode according to the response message received from the OFDM BS 312.

While the above described operation of the MS 300 was in reference to the OFDM module 302 communicating with the OFDM BS 312, substantially similar operations could also be performed by the MS 300 between the CDMA module 304 and a CDMA BS 314.

The following description is made of an exemplary operation method of a call control unit for transmitting a packet depending on states of communication modules included in an MS. In the following description, it is assumed that the call control unit stores operation state information on the communication modules included in the MS.

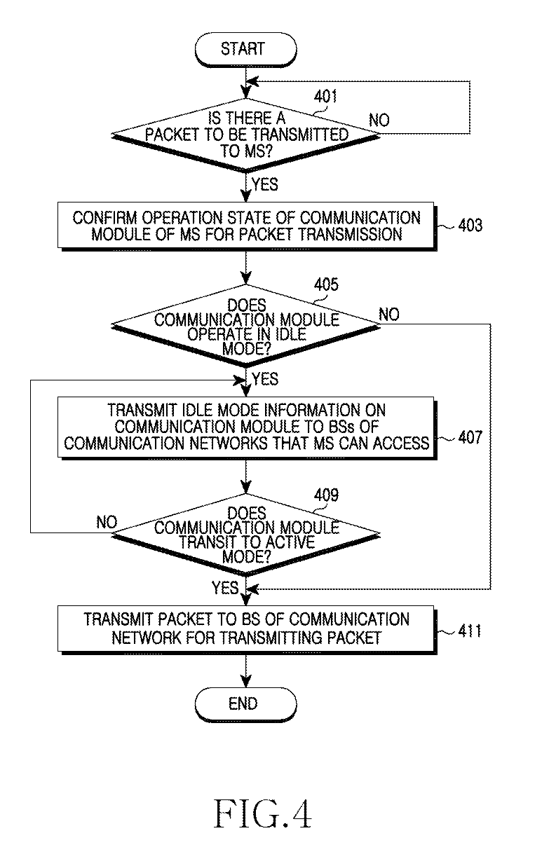

FIG. 4 illustrates a procedure for transmitting a paging message in a call control unit according to an exemplary embodiment of the present invention.

Referring to FIG. 4, in step 401, the call control unit determines if there is a packet to be transmitted to an MS. For example, the call control unit determines if an arbitrary user attempts a call to the MS through an access network.

If it is determined that there is a packet to be transmitted to the MS in step 401, the call control unit proceeds to step 403 and confirms an operation state of a communication module for packet transmission among the communication modules included in the MS.

In step 405 the call control unit determines if the communication module for packet transmission is operating in an idle mode. For example, if transmitting a packet to the MS through an OFDM communication network, the call control unit determines if an OFDM module of the MS is operating in the idle mode. For another example, if transmitting a packet to the MS through a CDMA communication network, the call control unit determines if a CDMA module of the MS is operating in the idle mode.

If it is determined that the communication module for packet transmission is not operating in the idle mode in step 405, the call control unit recognizes that the communication module for packet transmission is operating in an active mode. Accordingly, the call control unit proceeds to step 411 and transmits a packet to a BS of a communication network that the MS is accessing using the communication module for packet transmission. For example, if an OFDM module for packet transmission is in the active mode, the call control unit transmits a packet to an OFDM BS that the MS is accessing using the OFDM module.

On the other hand, if it is determined in step 405 that the communication module for packet transmission operates in the idle mode, the call control unit proceeds to step 407 and transmits idle mode information on the MS to at least two BSs that the MS can access. For example, if the MS can use a communication service of a CDMA scheme and a communication service of an OFDMA scheme, the call control unit transmits the idle mode information on the MS to a CDMA BS and an OFDM BS. Here, the idle mode information includes idle mode information on a communication module for packet transmission among communication modules included in the MS.

After that, the call control unit proceeds to step 409 and determines if the communication module for packet transmission transits to the active mode. For example, if the communication module for packet transmission transits to the active mode, a BS of the same communication network as that of the communication module transmits active mode transition information on the communication module to the call control unit. Accordingly, the call control unit can determine if the communication module for packet transmission transits to the active mode through the active mode transition information received from the BS.

If it is determined that the communication module for packet transmission does not transit to the active mode in step 409, the call control unit returns to step 407 and transmits the idle mode information on the MS to the at least two BSs that the MS can access.

On the other hand, if it is determined that the communication module for packet transmission transits to the active mode in step 409, the call control unit proceeds to step 411 and transmits a packet to a BS of a communication network to which the communication module operating in the active mode is in access.

Then, the call control unit terminates the procedure according to an exemplary embodiment of the present invention.

The following description is made of an exemplary operation method of a BS for transmitting a paging message depending on idle mode information on an MS received from a call control unit.

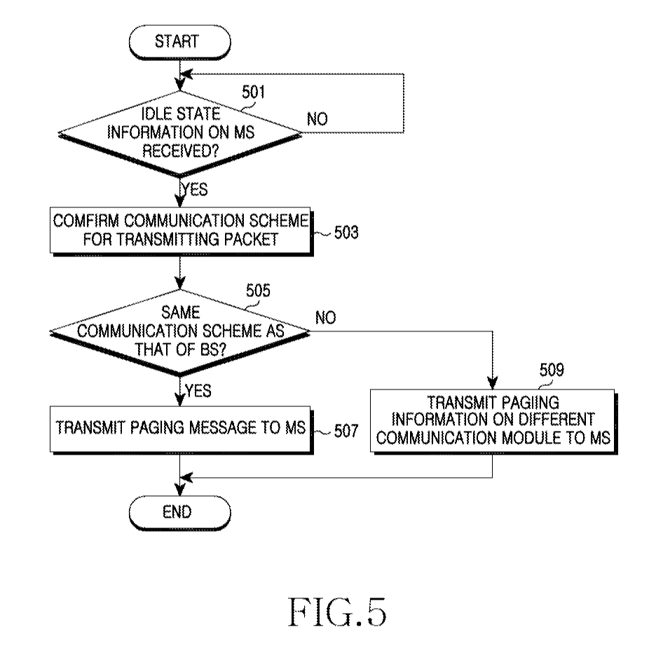

FIG. 5 illustrates a procedure for transmitting a paging message in a BS according to an exemplary embodiment of the present invention.

Referring to FIG. 5, in step 501, the BS determines if idle mode information on an MS is received from a call control unit. Here, the idle mode information may include idle mode information on a communication module for packet transmission among communication modules included in the MS.

If it is determined in step 501 that the idle mode information on the MS is received, the BS proceeds to step 503 and confirms a communication network corresponding to the communication module for packet transmission.

The BS proceeds to step 505 and determines if the communication network corresponding to the communication module for packet transmission is the same as a communication network of the BS.

If it is determined that the communication network corresponding to the communication module for packet transmission is the same as the communication network of the BS in step 505, the BS proceeds to step 507 and transmits a paging message to the MS considering a listening interval of a communication module operating in an idle mode.

On the other hand, if it is determined that the communication network corresponding to the communication module for packet transmission is the same as the communication network of the BS in step 505, the BS proceeds to step 509 and transmits paging information on the communication module for packet transmission to a communication module performing communication through the communication network of the BS among the communication modules of the MS. For example, when the BS uses a CDMA scheme and the communication module for packet transmission is an OFDM module, the BS transmits paging information on the OFDM module to a CDMA module of the MS. If the CDMA module is operating in an idle mode, the BS includes the paging information on the OFDM module in a paging message of the CDMA module and transmits the paging information on the OFDM module. On the other hand, if the CDMA module operates in an active mode, the BS transmits the paging information on the OFDM module to the CDMA module using a Media Access Control (MAC) header or a separately defined control signal.

Then, the BS terminates the procedure according to an exemplary embodiment of the present invention.

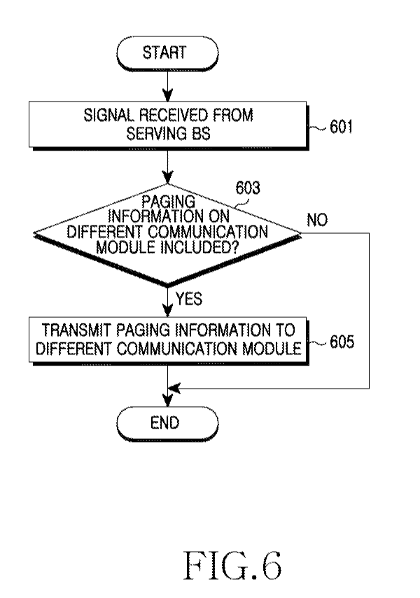

The following description is made of an exemplary operation method of an MS for receiving a paging message from a BS. If receiving paging information on a different communication module from the BS, a communication module of the MS operates as illustrated in FIG. 6 below.

FIG. 6 illustrates a procedure for determining paging information on a different communication module in a dual mode MS according to an exemplary embodiment of the present invention.

Referring to FIG. 6, in step 601, a communication module of the MS receives a signal from a serving BS. For example, a CDMA module of the MS receives a signal from a CDMA BS.

The communication module proceeds to step 603 and determines if paging information on a different communication module is included in the received signal. For example, a CDMA module determines if paging information on an OFDM module is included in the signal received from the CDMA BS.

If it is determined that the paging information on the different communication module is not included in the received signal in step 603, the communication module terminates the procedure according to an exemplary embodiment of the present invention.

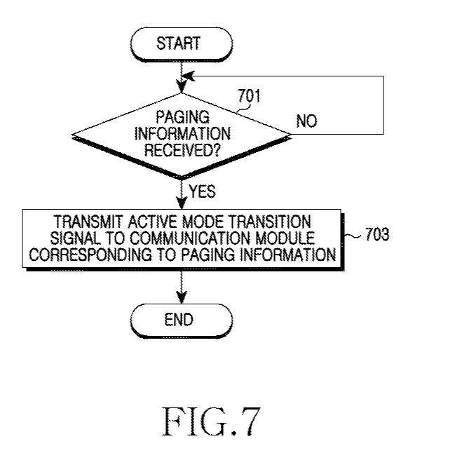

On the other hand, if it is determined that the paging information on the different communication module is included in the received signal in step 603, the communication module proceeds to step 605 and transmits the paging information on the different communication module to the different communication module. For example, if the CDMA module receives paging information on an OFDM module, the CDMA module transmits the paging information on the OFDM module to the OFDM module through a call management module. At this time, the call management module operates as illustrated in FIG. 7 below.

Then, the communication module terminates the procedure according to an exemplary embodiment of the present invention.

FIG. 7 illustrates a procedure for controlling an active mode transition of a communication module in a dual mode MS according to an exemplary embodiment of the present invention.

Referring to FIG. 7, in step 701, a call management module of the MS determines if paging information is received from at least one communication module among communication modules constituting the MS.

If it is determined that the paging information is received from the communication module in step 701, the call management module proceeds to step 703 and transmits an active mode transition signal to the communication module corresponding to the paging information. For example, if paging information on an OFDM module is received from a CDMA module, the call management module transmits an active mode transition signal to the OFDM module.

Then, the call management module terminates the procedure according to an exemplary embodiment of the present invention.

In the aforementioned exemplary embodiment of the present invention, a communication module of an MS receives paging information on a different communication module from a BS.

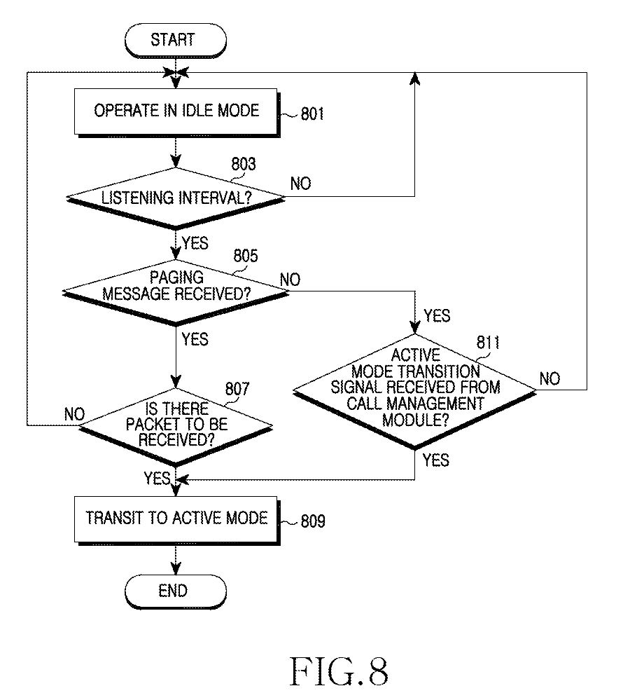

In another exemplary embodiment of the present invention, if a communication module of an MS receives paging information on the communication module from a BS, the communication module of the MS operates as illustrated in FIG. 8 below.

FIG. 8 illustrates a procedure for active mode transition in a dual mode MS according to an exemplary embodiment of the present invention.

Referring to FIG. 8, in step 801, a communication module of the MS operates in an idle mode to reduce power consumption. For example, as illustrated in FIG. 3, a communication module not performing communication for a predefined time transitions to the idle mode.

The communication module proceeds to step 803 and determines if a listening interval arrives every paging period. In an exemplary implementation, the communication module determines the paging period and the listening interval in idle mode operation information received from a serving BS.

If it is determined that the current time is not in the listening interval in step 803, the communication module returns to step 801 and operates in the idle mode.

On the other hand, if it is determined that the listening interval arrives in step 803, the communication module proceeds to step 805 and determines if a paging message is received from the serving BS.

If it is determined that the paging message is received from the serving BS during the listening interval in step 805, the communication module proceeds to step 807 and determines if there is a packet for the communication module to receive through the paging message.

If it is determined that there is no packet to be received from the serving BS in step 807, the communication module returns to step 801 and operates in the idle mode.

On the other hand, if it is determined that there is a packet to be received from the serving BS in step 807, the communication module proceeds to step 809 and transits to an active mode.

Referring again to step 805, if the paging message is not received from the serving BS during the listening interval, the communication module proceeds to step 811 and determines if an active mode transition signal is received from a call management module.

If it is determined that the active mode transition signal is not received in step 811, the communication module returns to step 801 and operates in the idle mode.

On the other hand, if it is determined that the active mode transition signal is received in step 811, the communication module proceeds to step 809 and transits to the active mode.

Then, the communication module terminates the procedure according to an exemplary embodiment of the present invention.

The following description is made for a construction of a call control unit for controlling to transmit a paging message depending on operation states of communication modules constituting an MS.

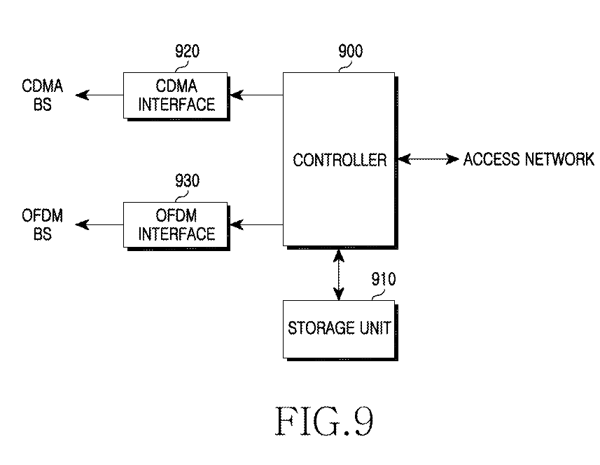

FIG. 9 illustrates a construction of a call control unit for transmitting a paging message to a dual mode MS according to an exemplary embodiment of the present invention.

As illustrated in FIG. 9, the call control unit includes a controller 900, a storage unit 910, a CDMA interface 920, and an OFDM interface 930.

The controller 900 selects a BS to transmit a packet to an MS depending on a communication network for transmitting a packet. For example, if transmitting a packet in a CDMA scheme, the controller 900 controls to transmit the packet to the MS through a CDMA BS. On the other hand, if transmitting a packet in an OFDMA scheme, the controller 900 controls to transmit the packet to the MS through an OFDM BS.

If a communication module of an MS to receive a packet operates in an idle mode, the controller 900 controls to transmit idle mode information on the MS to BSs that the MS can access. For example, if the MS can access the CDMA BS and the OFDM BS, the controller 900 transmits the idle mode information on the MS to the CDMA BS and the OFDM BS. Here, the idle mode information includes information on a communication module for packet transmission among communication modules included in the MS.

The storage unit 910 stores registration information and operation state information on the communication modules of the MS that provides a service through the CDMA BS and the OFDM BS.

The CDMA interface 920 transmits/receives a signal with the CDMA BS through a wired link that connects with the CDMA BS.

The OFDM interface 930 transmits/receives a signal with the OFDM BS through a wired link that connects with the OFDM BS.

The following description is made for a construction of a BS for transmitting a paging message depending on control of the call control unit.

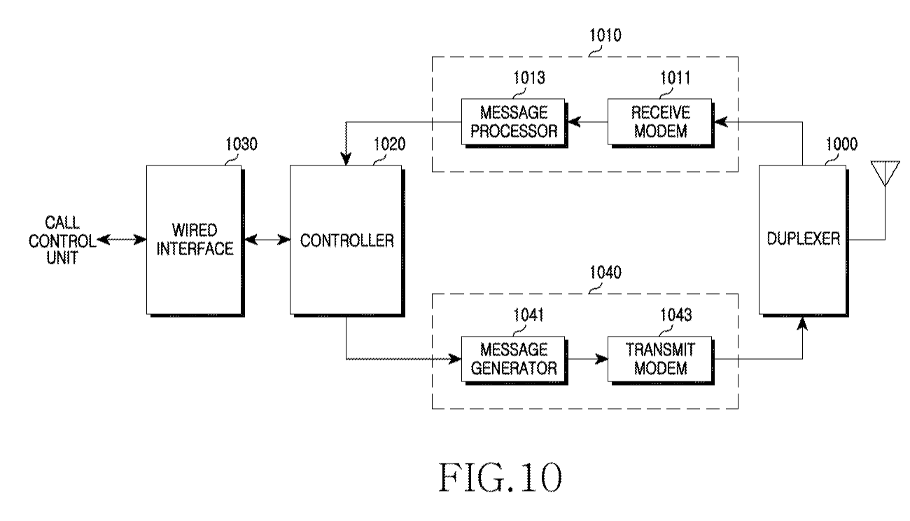

FIG. 10 illustrates a construction of a BS for transmitting a paging message to a dual mode MS according to an exemplary embodiment of the present invention.

As illustrated in FIG. 10, the BS includes a duplexer 1000, a receiver 1010, a controller 1020, a wired interface 1030, and a transmitter 1040.

According to a duplexing scheme, the duplexer 1000 transmits a transmit signal received from the transmitter 1040 through an antenna, and provides a receive signal from the antenna to the receiver 1010.

The receiver 1010 includes a receive modulator/demodulator (modem) 1011 and a message processor 1013.

The receive modem 1011 converts a high frequency signal received through the antenna in accordance with a communication scheme of the BS and outputs the converted signal. For example, the receive modem 1011 converts a high frequency signal received through the antenna into a baseband signal. Then, the receive modem 1011 converts the baseband signal into a frequency domain signal through Fast Fourier Transform (FFT). For another example, the receive modem 1011 converts a high frequency signal received through the antenna into a baseband signal. Then, the receive modem 1011 de-spreads the baseband signal and outputs the de-spreaded signal.

The message processor 1013 extracts a control signal from a signal received from the receive modem 1011 and transmits the extracted control signal to the controller 1020. For example, the message processor 1013 extracts an idle mode transition request message transmitted by the MS from the signal received from the receive modem 1011 and transmits the extracted idle mode transition request message to the controller 1020.

The controller 1020 controls a general operation of the BS, and controls operation transitions of MSs that are located in a service area. For example, if receiving the idle mode transition request message through the message processor 1013, the controller 1020 determines operation information for an idle mode transition of the MS transmitting the idle mode transition request message. Here, the operation information includes a time at which the MS transitions to an idle mode, a paging period, a listening interval length, etc.

Also, if receiving idle mode information on an MS from a call control unit through the wired interface 1030, the controller 1020 controls to transmit paging information depending on the idle mode information on the MS. For example, if receiving idle mode information on a CDMA module, a CDMA BS transmits a paging message to the CDMA module considering the idle mode operation information on the CDMA module. For another example, if receiving the idle mode information on the CDMA module, an OFDM BS transmits paging information on the CDMA module to an OFDM module. At this time, if the OFDM module operates in an idle mode, the OFDM BS includes the paging information on the CDMA module in a paging message of the OFDM module and transmits the paging information on the CDMA module. On the other hand, if the OFDM module operates in an active mode, the OFDM BS transmits the paging information on the CDMA module to the OFDM module using a MAC header or a separately defined control signal.

The wired interface 1030 transmits/receives a signal with the call control unit through a wired link that connects with the call control unit.

The transmitter 1040 includes a message generator 1041 and a transmit modem 1043.

The message generator 1041 generates a control message to be transmitted to an MS depending on control of the controller 1020. For example, the message generator 1041 generates a paging message for a communication module operating in an idle mode depending on control of the controller 1020. For another example, the message generator 1041 generates paging information on a different communication module depending on control of the controller 1020. At this time, the message generator 1041 generates a paging message including the paging information on the different communication module or generates the paging information on the different communication module such that the paging information on the different communication module is included in a MAC header or a separately defined control signal.

The transmit modem 1043 converts a message or packet to be transmitted to an MS into a high frequency signal depending on a communication scheme of the BS, and outputs the high frequency signal through the antenna. For example, if the BS uses an OFDMA scheme, the transmit modem 1043 converts a transmit signal into a time domain signal through Inverse Fourier Transform (IFT), converts the time domain signal into a high frequency signal, and outputs the high frequency signal through the antenna. On the other hand, if the BS uses a CDMA scheme, the transmit modem 1043 spreads a transmit signal, converts the spreaded transmit signal into a high frequency signal, and outputs the high frequency signal through the antenna.

The following description is made of an exemplary construction of an MS for receiving a paging message from a BS.

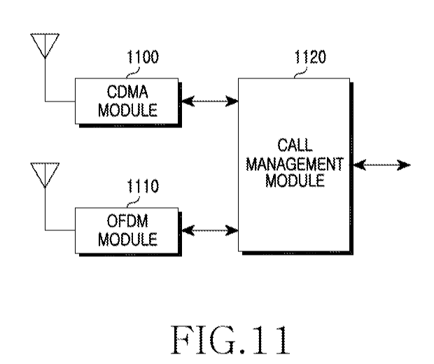

FIG. 11 illustrates a construction of a dual mode MS according to an exemplary embodiment of the present invention.

As illustrated in FIG. 11, the MS includes a CDMA module 1100, an OFDM module 1110, and a call management module 1120.

The CDMA module 1100 processes a transmit/receive signal to perform communication with a CDMA BS using a CDMA communication scheme. If paging information on the OFDM module 1110 is included in a signal received from the CDMA BS, the CDMA module 1100 transmits the paging information to the call management module 1120.

The OFDM module 1110 processes a transmit/receive signal to perform communication with an OFDM BS using an OFDM communication scheme. If paging information on the CDMA module 1100 is included in a signal received from an OFDM BS, the OFDM module 1110 transmits the paging information to the call management module 1120.

The call management module 1120 converts signals received from different communication modules such that an upper end can process the signals irrespective of a communication scheme, and transmits the converted signals to the upper end. Also, the call management module 1120 converts a signal received from the upper end into a signal suitable to each communication module, and provides the converted signal to a corresponding communication module.

If receiving paging information on a different communication module from each communication module, the call management module 1120 transmits an active mode transition instruction signal to the different communication module.

As described above, exemplary embodiments of the present invention transmit a paging message of a dual mode MS together to a first communication module and a second communication module that operate in an idle mode, thereby being capable of advantageously increasing the reliability of paging message transmission and reducing a response delay time of the MS responsive to the paging message in a wireless communication system.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for operation transition of a communication module operating in an idle mode in a mobile communication terminal having at least two communication modules, the method comprising:
when a listening interval arrives, determining if a paging message is received;
when the paging message is not received during the listening interval, determining if paging information on the communication module is received from a different communication module; and
when the paging information is received from the different communication module, transiting to an active mode.

2. The method of claim 1, wherein the communication module and the different communication module communicate using one of a Code Division Multiple Access (CDMA) scheme and an Orthogonal Frequency Division Multiple Access (OFDMA) scheme,
wherein, the communication module and the different communication module communicate using different communication schemes.

3. The method of claim 1, further comprising, if the paging information is not received from the different communication module, operating in an idle mode.

4. The method of claim 1, further comprising:
if the paging message is received during the listening interval, determining if there is a signal for the communication module to receive in the paging message;
if there is the signal to receive, transiting to an active mode; and
if there is no signal to receive, operating in an idle mode.

5. The method of claim 4, further comprising, if paging information on the different communication module is included in the paging message received during the listening interval, transmitting the paging information to the different communication module.

6. The method of claim 5, wherein the transmitting of the paging information comprises transmitting active mode transition instruction information to the different communication module corresponding to the paging information.

7. A method for controlling paging message transmission in a call control unit of a wireless communication system, the method comprising:
if transmitting a packet to a Mobile Station (MS), determining an operation state of a first communication module for packet transmission among at least two communication modules constituting the MS; and
if the first communication module operates in an idle mode, transmitting idle mode information on the first communication module to at least two Base Stations (BSs) of different communication schemes that the MS can access.

8. The method of claim 7, further comprising, if the first communication module operates in an active mode, transmitting a packet to a BS of the same communication scheme as that of the first communication module.

9. A method for transmitting a paging message in a Base Station (BS) of a wireless communication system, the method comprising:
if receiving, from a call control unit, idle mode information on a first communication module that is one of at least two communication modules constituting a Mobile Station (MS), determining a communication scheme of the first communication module; and
if the communication scheme of the first communication module is different from a communication scheme of the BS, transmitting paging information on the first communication module to a second communication module using the same communication scheme as the BS among the at least two communication modules constituting the MS.

10. The method of claim 9, wherein the transmitting of the paging information on the first communication module comprises:
transmitting the paging information on the first communication module in one of a paging message transmitted to the second communication module, a Media Access Control (MAC) header of a signal transmitted to the second communication module, and a control signal transmitted to the second communication module; and
transmitting the paging information on the first communication module to the second communication module.

11. The method of claim 9, further comprising, if the communication scheme of the first communication module is the same as the communication scheme of the BS, transmitting a paging message to the first communication module.

12. A mobile communication Mobile Station (MS) apparatus having at least two communication modules, the apparatus comprising:
a first communication module for, if paging information on a second communication module is received from a serving Base Station (BS) of a first communication scheme, transmitting the paging information on the second communication module to the second communication module operating in an idle mode; and
the second communication module for, when operating in the idle mode, if paging information on the second communication module is received from the first communication module although a paging message is not received during a listening interval, transiting to an active mode.

13. The apparatus of claim 12, wherein the first communication module and the second communication module communicate using one of a Code Division Multiple Access (CDMA) scheme and an Orthogonal Frequency Division Multiple Access (OFDMA) scheme,
wherein, the first communication module and the second communication module communicate using different communication schemes.

14. The apparatus of claim 12, wherein, if not receiving the paging message during the listening interval and not receiving the paging information from the first communication module, the second communication module maintains the idle mode.

15. The apparatus of claim 12, wherein, when the paging message is received during the listening interval, if it is determined that there is a signal for the second communication module to receive in the paging message, the second communication module transitions to the active mode and, if it is not determined that there is a signal for the second communication module to receive in the paging message, maintains the idle mode.

16. A call control apparatus for controlling paging message transmission in a wireless communication system, the apparatus comprising:
a storage unit for storing operation state information on at least two communication modules constituting a Mobile Station (MS);
at least two interfaces for performing communication with Base Stations (BSs) of different communication schemes; and
a controller for, if a first communication module for packet transmission among the communication modules constituting the MS operates in an idle mode, controlling to transmit idle mode information on the first communication module to the at least two BSs of the different communication schemes that the MS can access through the interfaces.

17. The apparatus of claim 16, wherein, if the first communication module operates in an active mode, the controller controls to transmit a packet to a BS of the same communication scheme as that of the first communication module.

18. A Base Station (BS) apparatus for transmitting a paging message in a wireless communication system, the apparatus comprising:
a wired interface for performing communication with a call control unit;
a transmitter for transmitting a signal;
a receiver for receiving a signal; and
a controller for, if receiving idle mode information on a first communication module using a communication scheme different from a BS among at least two communication modules constituting a Mobile Station (MS) through the wired interface, controlling to transmit paging information on the first communication module to a second communication module using the same communication scheme as the BS.

19. The apparatus of claim 18, wherein the transmitter comprises the paging information on the first communication module in one of a paging message transmitted to the second communication module, a Media Access Control (MAC) header of a signal transmitted to the second communication module, and a control signal transmitted to the second communication module, and transmits the paging information on the first communication module to the second communication module.

20. The apparatus of claim 18, wherein, if receiving idle mode information on the second communication module among the at least two communication modules constituting the MS through the wired interface, the controller controls to transmit a paging message to the second communication module.
